(19) United States
(12) Patent Application Publication
(10) Pub. No.: US 2018/0144415 A1
(43) Pub. Date: May 24, 2018

(54) System and Method for Creating Gasoline Contract

(71) Applicant: Amir Rahmoun, Clifton, NJ (US)

(72) Inventor: Amir Rahmoun, Clifton, NJ (US)

(21) Appl. No.: 15/481,830

(22) Filed: Apr. 7, 2017

Related U.S. Application Data
(63) Continuation-in-part of application No. 15/358,536, filed on Nov. 22, 2016, now abandoned.

(51) Int. Cl. G06Q 50/06; G06Q 30/02; G06Q 40/04

(52) U.S. Cl. CPC G06Q 50/06; G06Q 40/04; G06Q 30/0209

(57) ABSTRACT

A system and method for providing a fuel pricing program relating to purchases of vehicle fuel. The method comprises the steps of connecting to a server having a user database and merchant database, determining fuel allotment based on data received from the user database, generating a user fuel price based on data received from the merchant database, generating a contract price based on fuel allotment and user fuel price, generating an incentive based on rewards obtained through an electronic game played by the user, finalizing a contract and generating a charge card. The user database comprises a contract term and fuel efficiency of the user's vehicle, and geographic area of the user, and the merchant database comprises wholesale fuel price, sales volume and discounts offered by fuel merchants, and wholesale fuel price based on geographic area. The system comprises an input device and a processor for implementing the method.

### CROSS-REFERENCE TO RELATED APPLICATIONS

This application is a continuation-in-part of U.S. application Ser. No. 15/358,536, filed on Nov. 22, 2016, which is incorporated by reference.

### FIELD

The present disclosure relates to the creation of gasoline contracts, in particular to a system and method for creating risk-adjusted gasoline contracts.

### BACKGROUND

The point of sale for a vehicle purchase or lease is the best opportunity to offer customers with value-added services. While vehicle maintenance and car insurance are routinely sold to customers, the other major cost of vehicle ownership, gasoline, is not Gasoline is difficult to offer because of the uncertainty of gasoline prices and level of consumption by the customer.

Attempts to sell gasoline rebates or prebates in the prior art rely on fixing the consumption and employing hedging strategies to hedge against the gasoline price risk, such as purchasing gasoline futures. This involves additional hedging costs, including the taxation of capital gains. In addition, only price changes for gasoline at the point of delivery for the futures are hedged. Variables such as costs associated with delivery to the point of sale, reformulation of the gasoline, and taxes are not hedged. Additional steps are required to account for those costs, which are not always easy to determine.

Therefore, a need exists for a more efficient system and method for providing risk-adjusted gasoline contracts.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The system and method for providing gasoline contracts of the present invention solves the problems of the prior art and provides additional advantages.

In general, the method of the present invention comprises: (i) connecting to the server using the user interface; (ii) querying a user database for a contract term and a mileage allotment (iii) determining a gasoline allotment based on the mileage allotment and a miles per gallon (MPG); (iv) generating a gasoline price based on the merchant database; (v) generating a contract price based on the gasoline allotment and the gasoline price; (vi) generating an incentive; (vii) finalizing the contract; (viii) generating the charge card; (ix) updating the user database and merchant database at each use of the charge card.

Thus, the present invention provides a method operable on a computer for providing a fuel pricing program relating to purchases of vehicle fuel, comprising the steps of: connecting to a server, wherein the server comprises a user database comprising a contract term and fuel efficiency of the user's vehicle, and geographic area of the user; and a merchant database comprising wholesale fuel price, sales volume and discounts offered by fuel merchants, and wholesale fuel price based on geographic area; determining fuel allotment based on data received from the user database; generating a user fuel price based on data received from the merchant database; generating a contract price based on fuel allotment and user fuel price; generating an incentive based on rewards obtained through an electronic game played by the user; finalizing a contract; and generating a charge card.

In general, the system of the present invention comprises: (i) a user interface; (ii) a server; (iii) a gasoline contract; and (v) a charge card.

Thus, the present invention provides a system for providing a fuel pricing program relating to purchases of vehicle fuel, comprising: an input device for receiving data relating to a user and the user's vehicle; a processor for executing a pre-determined fuel pricing program for implementing: a first algorithm for determining fuel allotment; a second algorithm for determining user fuel price; and a third algorithm for determining contract price. The first algorithm includes processing user data. The user data comprises at least one of: a lease term of the user's vehicle, fuel efficiency of the user's vehicle and geographic location of the user. The second algorithm includes processing merchant data. The merchant data comprises at least one of: wholesale fuel price, merchant's sales volume, discounts offered by fuel merchants and wholesale fuel price based on geographic area. The third algorithm includes processing the user data and merchant data.

The gasoline contract price is determined using prices compiled from gasoline merchants, directly or indirectly. This eliminates the complex process of determining component costs to arrive at a contract price.

The contracts are pooled together into a single risk pool with the gasoline allotment fixed at a level sufficient to pay for the gasoline consumption for the entire pool. In this way, the seller's losses from over-consumption by some users can be offset by the seller's profits from under-consumption by other users. As users are indifferent to the price of gasoline within their allotments, demand should be inelastic, resulting in a stable and more predictable consumption rate.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not, limited to the precise arrangements and instrumentalities shown.

In the drawings:

FIG. 1 is an illustration of the system of the present invention;

FIG. 2 is a flow chart of the method of the present invention; and

FIG. 3 is an illustration of the system and method of the present invention.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

Certain terminology is used in the following description for convenience only and is not limiting. The article “a” is intended to include one or more items, and where only one item is intended the term “one” or similar language is used.

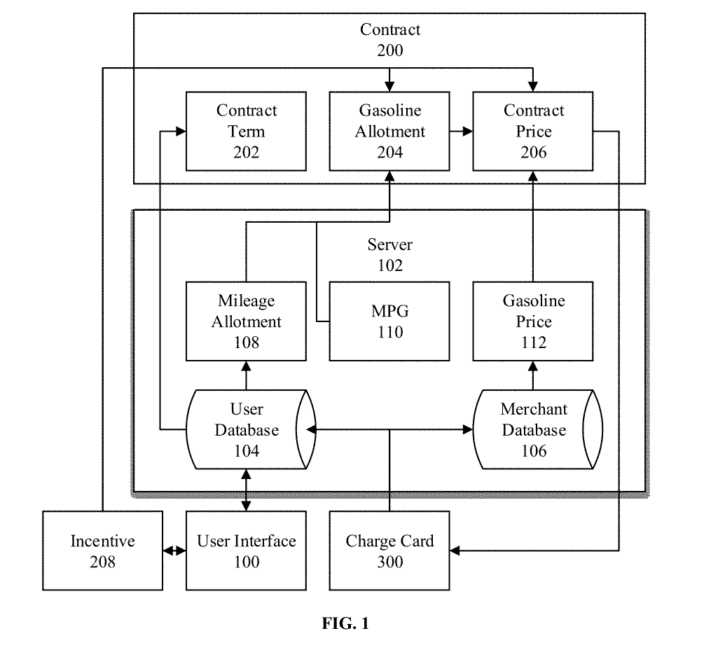

As shown in FIG. 1, the system of the present invention comprises: (i) a user interface 100; (ii) a server 102; (iii) a gasoline contract 200; and (v) a charge card 300.

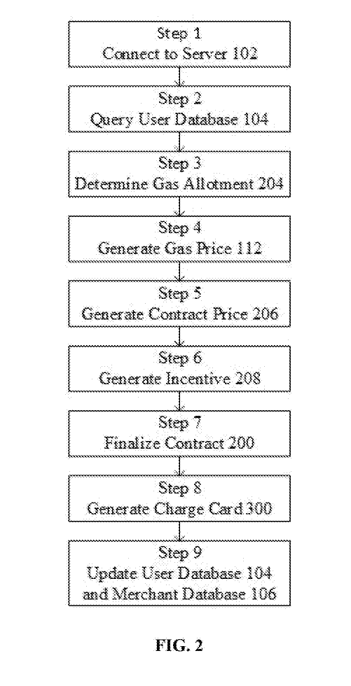

As shown in FIG. 2, the method of the present invention comprises: (i) connecting to the server 102 using the user interface 100; (ii) querying a user database 104 for a contract term 202 and a mileage allotment 108; (iii) determining a gasoline allotment 204 based on the mileage allotment 108 and a miles per gallon (MPG) 110; (iv) generating a gasoline price 112 based on the merchant database 106; (v) generating a contract price 206 based on the gasoline allotment 204 and the gasoline price 112; (vi) generating, an incentive 208; (vii) finalizing the contract 200; (viii) generating the charge card 300; (ix) updating the user database 104 and merchant database 106 at each use of the charge card 300.

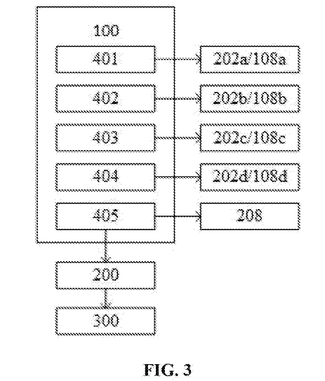

Referring to the first step, the user interface 100 connects to the server 102. The user interface 100, shown for example in FIG. 3, is a local or remote application running on a computer, tablet, or other device capable of securely connecting to a server 102. The server 102 comprises the user database 104 and the merchant database 106. The user database 104 comprises information about the user, such as information tied to the user's vehicle lease. The merchant database 106 comprises information about gasoline merchants, such as gasoline prices and sales volume, and discounts offered by merchant.

In the preferred embodiment, the user interface 100 is a secure web application served from the server 102 and running on a touchscreen, as shown in FIG. 3, at the point of sale. This enables sales associates to use the more up-to-date version of the interface without having to download updated applications.

Referring to the second step, the user inputs into the user interface 100 the desired term 202 of the contract and desired mileage allotment 108 per period, where the period is daily, weekly, monthly, the entire term 202, or other period. If the user has a vehicle lease, the user's account associated with the lease can be queried for the lease end date and allotted mileage. Alternatively, a vehicle lease or vehicle purchase, other vehicle upgrade options, and the method of the present invention can be executed concurrently on the same system. The lease end date can serve as the default value for the term 202. The allotted mileage per the terms of the vehicle lease can serve as the default value for the mileage allotment 108. The mileage allotment can vary through the term 202. For example, more mileage can be allotted for summer months when the user is more likely to require more mileage.

As shown in FIG. 3, in the preferred embodiment, the user is presented with a plurality of options 401-405 for the term 202 and mileage allotment 108. For example, the user can choose between 3 years (202a) at 15,000 miles per year (108a), 3 years (202b) at 12,000 miles per year (108b), 3 years (202c) at 10,000 miles per year (108c), or an unlimited term (202d) at 100,000 miles total (108d).

Referring to the third step, the gasoline allotment 204 is determined by dividing the mileage allotment 108 by a fixed MPG 110 used for all users at any given time, e.g., 25 MPG or 30 MPG. The fixed MPG 110 is, a projection, using past gasoline consumption data, sufficient to pay for the gasoline consumption of the entire pool of users. In another embodiment, the allotted mileage according to the lease terms is divided by an MPG that varies by vehicle.

Referring to the fourth step, the gasoline price 112 is determined using data from the merchant database 106. The merchant database 106 comprises the gasoline prices of each octane rating sold by merchants as compiled from data provided directly by merchants, third-party databases, existing users, surveys of merchants, or a combination thereof. The gasoline price 112 is determined by averaging the prices for the past year for the minimum octane rating recommended for the user's vehicle, A full year is used to adjust for the seasonal variability in gasoline prices. The prices can be weighted by the merchant's sales volume in order to arrive at a price that better reflects actual gasoline consumption, i.e., prices for merchants that are more popular would be weighted more heavily than the prices for less popular merchants. The price can, also be increased to pay for the cost of an incentive 208 to be determined in the sixth step.

In one embodiment, the geographic scope of the contract 200 is limited. For example, the contract 200 can apply to a single state. The gasoline price 112 would be determined by averaging prices only for the geographic area covered by the contract 200.

In another embodiment, the merchants covered by the contract 200 are limited to only qualifying merchants. In that case, the gasoline price 112 would be determined by averaging prices only for the qualifying merchants.

Referring to the fifth step, the contract price 206 is determined by multiplying the gasoline price 112 and the gasoline allotment 204. The contract price 206 can reflect a payment period of daily, weekly, month, or other period, tied to or independent of the period used for the gasoline allotment 204.

Referring to the sixth step, the user can be offered an incentive 208, including an opportunity to lower the contract price or increase the gasoline allotment. For example, as shown in FIG. 3, the user can be offered a chance to play a game 405 on the user interface 100 that rewards users with a discount on the contract price 206 or additional gasoline allotment 204. The opportunity to receive a lower price or increased benefits provides the user with additional incentives to enter the contract 200. The cost of the incentive 208 is paid for by an increase in the gasoline price 112 in the fourth step.

Referring to the seventh step, as shown in the figures, the incentive 208 is applied to the contract 200 to produce a final contract 200 for the user to accept.

Referring to the eighth step, as shown in the figures, a charge card 300 is generated for the user. The charge card 300 enables the user to purchase gasoline up to the gasoline allotment 204 for the period from qualifying merchants within the covered geographic area. In the preferred, embodiment, the charge card 300 is a traditional credit card with a credit limit sufficient to cover at least filling up a vehicle at the prevailing gasoline price. The credit limit can be adjusted periodically to the changing price of gasoline.

Gasoline purchases are reimbursed to the charge card 300 while non-gasoline purchases are not. This enables the charge card 300 to be accepted by any merchant that accepts traditional credit cards. In an alternative embodiment, the charge card 300 can only be used for the purchase of gasoline. Charges can record the specific merchant, the octane rating, the number of gallons purchased, and other information. Collecting this information may require merchant cooperation.

If used at a non-participating merchant, the charge card 300 can be rejected or, alternatively, the charge card can have a fall-back option that enables it to function as a traditional credit card according to the preferred embodiment.

Mobile applications can enable the user to locate participating merchants as well as view information about the charge card 300 and the contract 200, including remaining gasoline allotment 204.

As a further measure to prevent fraud and to protect the seller from excessive losses, the reimbursed amount can be capped. The cap can be a cap on the price per gallon or the total purchase amount. For example, the price per gallon to be reimbursed can be capped at some amount above the gasoline price 112.

Referring to the ninth step, the user database 104 and merchant database 106 are updated with information about every purchase made with the charge card 300. Once the gasoline allotment 204 is used up, reimbursements to the charge card 300 are no longer made or the charge card 300 is disabled.

It will be understood that the commodity price of gasoline can be hedged through the purchase of appropriate financial derivatives, including futures contracts and options. However, in addition to the actual gasoline commodity price, there are additional, more volatile costs associated with the delivery of gasoline to the pump. These costs include, for example, the cost of transportation, the retail margin and both federal and local taxes. No traditional hedges exist for these more volatile costs.

Accordingly, there will be many different methods of calculating a consumer program price under the present program. Without limitation, different methodologies include: including the tax as a fixed cost included within the program price and assuming the risks associated with fluctuations of the tax; adding the actual tax associated with each purchase into the program price such that the program price comprises a fixed base price plus tax; providing a single, geographically independent program price: and, providing a series of program prices that vary with the geographic location of the gasoline fuel purchase.

The present invention may be embodied in other specific forms without departing from its spirit or essential characteristics. The described embodiments are to be considered in all respects only as illustrative and not restrictive. The scope of the invention will be, therefore, indicated by claims rather than by the foregoing description. All changes, which come within the meaning and range of equivalency of the claims, are to be embraced within their scope.

1. A method operable on a computer for providing a fuel pricing program relating to purchases of vehicle fuel, comprising the steps of:
connecting to a server, wherein the server comprises:
a user database comprising a contract term and fuel efficiency of the user's vehicle, and geographic area of the user; and
a merchant database comprising wholesale fuel price, sales volume and discounts offered by fuel merchants, and wholesale fuel price based on geographic area;
determining fuel allotment based on data received from the user database;
generating a user fuel price based on data received from the merchant database;
generating a contract price based on fuel allotment and user fuel price;
generating an incentive based on rewards obtained through an electronic game played by the user;
finalizing a contract; and
generating a charge card.

2. The method of claim 1, wherein the user database further comprises a fund balance and the merchant database further comprises data relating to use of the charge card.

3. The method of claim 2, further comprising a step of updating the user database and merchant database at each use of the charge card.

4. A method operable on a computer for providing a fuel pricing program relating to purchases of vehicle fuel, comprising the steps of:
connecting to a server;
querying a user database;
determining fuel allotment;
generating a user fuel price;
generating a contract price;
generating an incentive;
finalizing a contract; and
generating a charge card.

5. The method of claim 4, wherein the server comprises a user database and a merchant database, the user database having information about the user and the merchant database having information about fuel merchants.

6. The method of claim 5, wherein the user database comprises a lease term and fuel efficiency of the user's vehicle to determine fuel allotment.

7. The method of claim 6, wherein fuel efficiency is set at a pre-determined value.

8. The method of claim 7, wherein the pre-determined value is selected from a group comprising 25 miles per gallon and 30 miles per gallon.

9. The method of claim 6, wherein the user database further comprises geographic area of the user.

10. The method of claim 6, wherein the merchant database comprises wholesale fuel price, sales volume and discounts offered by fuel merchants to determine the user fuel price.

11. The method of claim 10, wherein the merchant database further comprises wholesale fuel price based on geographic area.

12. The method of claim 10, wherein the user fuel price is determined by calculating an average price of fuel for 12 months prior to contract for the minimum octane rating recommended for the user's vehicle.

13. The method of claim 10, wherein the contract price is determined based on fuel allotment and user fuel price.

14. The method of claim 10, wherein the incentive is determined by rewards obtained through an electronic game played by the user.

15. A system for providing a fuel pricing program relating to purchases of vehicle fuel, comprising:
an input device for receiving data relating to a user and the user's vehicle;
a processor for executing a pre-determined fuel pricing program for implementing:
a first algorithm for determining fuel allotment;
a second algorithm for determining user fuel price; and
a third algorithm for determining contract price.

16. The system of claim 15, wherein the first algorithm includes processing user data.

17. The system of claim 16, wherein the user data comprises at least one of: a lease term of the user's vehicle, fuel efficiency of the user's vehicle and geographic location of the user.

18. The system of claim 15, wherein the second algorithm includes processing merchant data.

19. The system of claim 18, wherein the merchant data comprises at least one of: wholesale fuel price, merchant's sales volume, discounts offered by fuel merchants and wholesale fuel price based on geographic area.

20. The system of claim 15, wherein the third algorithm includes processing:
user data comprising at least one of: a lease term of the user's vehicle, fuel efficiency of the user's vehicle and geographic location of the user; and
merchant data comprising at least one of: wholesale fuel price, merchant's sales volume, discounts offered by fuel merchants and wholesale fuel price based on geographic area.
